(19) United States
(12) Patent Application Publication
(10) Pub. No.: US 2019/0184607 A1
(43) Pub. Date: Jun. 20, 2019

(54) FORMING SYSTEM AND FORMING METHOD USING SAME

(71) Applicant: DANYANG CHENGTAI PLASTIC CO., LTD., Zhenjiang, Jiangsu (CN)

(72) Inventors: Fubao CHENG, Zhenjiang (CN); Binsheng CHENG, Zhenjiang (CN)

(21) Appl. No.: 16/318,822

(22) PCT Filed: Aug. 18, 2017
(86) PCT No.: PCT/CN2017/098050

§ 371 Date: Jan. 18, 2019

(30) Foreign Application Priority Data
Aug. 19, 2016 (CN) 201610692171.4

(51) Int. Cl. B29C 31/08; B29C 48/91; B29C 49/04; B29C 49/64; B29C 49/78

(52) U.S. Cl. CPC B29C 31/08; B29C 48/91; B29C 49/78; B29C 49/64; B29C 49/04

(57) ABSTRACT

The present invention relates to the technical field of forming, and discloses a forming system and a forming method using the same, to solve a problem that a forming process in the prior art is intermittent and therefore has relatively low production efficiency. The forming system of the present invention includes: a main machine and a forming machine that are located at a same production line and are sequentially connected. The main machine includes an extrusion mechanism, and the forming machine includes a forming mechanism. The main machine can heat and stir a solid raw material into a liquid material by using the extrusion mechanism. The forming machine can directly process the viscous material into a formed product by the forming mechanism. The present invention is mainly applied to production and manufacturing of plastic products.

### FIELD OF THE INVENTION

The present invention relates to the field of forming technologies, and in particular, to a forming system and a forming method using the same.

### BACKGROUND OF THE INVENTION

Forming is a process of using an external force, a tool or a mold to process a raw material or a blank (a semi-finished product) into a blank body or a product that has a particular shape and size and has an organizational structure and mechanical performance. Forming is often applied in a process of processing plastic products.

Devices and apparatuses that are mainly used in a forming process in the prior art include: a stirrer, an extruder, a roller press, a sheet extruder, a thermoforming machine, and a grinder. In addition, the forming process in the prior art may mainly include a sheet processing process and a product forming process. Specifically, the stirrer can be used to stir and mix a plurality of raw materials (for example, a primary material such as plastic and resin and an additive material such as a plasticizer, a filler, a lubricant, and a colorant), and turn the raw materials into a mixture and a material having appropriate viscosity. The extruder can be used to thoroughly plasticize and uniformly mix the material and perform initial forming by using a die. The roller press can be used to process the initially formed material by using pressing rollers to further form a coiled sheet. During the foregoing sheet processing and forming, the raw materials need to be heated to enter a molten state before the extruder can perform initial forming, and need to be cooled to room temperature after passing through the roller press before the coiled sheet can be formed. Further, the thermoforming machine can be used to process the coiled sheet into various required products by using corresponding molds, to perform final forming. The grinder can be used to grind cut edges of products and then enable the ground cut edges to enter the stirrer again to realise scrap reuse. During the final forming of the foregoing products, the coiled sheet at room temperature needs to be heated again to enter a molten state to enter the thermoforming machine to be tightly attached to a mold for final forming.

However, the inventor of this application finds that in an existing forming process, the coiled sheet at room temperature needs to be heated to enter a molten state before entering the thermoforming machine, and such a process takes some time. As a result, the existing forming process is inevitably intermittent, and the production efficiency is relatively low.

### SUMMARY OF THE INVENTION

The objective of the present invention is to provide a forming system and a forming method using the same, to solve the problems of relatively low production efficiency and high energy consumption since a forming process in the prior art is intermittent.

The present invention provides a forming system, including: a main machine and a forming machine that are located at a same production line and are sequentially connected, where the main machine includes an extrusion mechanism, the forming machine includes a forming mechanism, the main machine can heat and stir a solid raw material into a viscous material by using the extrusion mechanism, and the forming machine can directly process the viscous material into a formed product by using the forming mechanism.

During actual application, a cooler is connected between the main machine and the forming machine, and the cooler can be used to reduce the temperature of the high-temperature viscous material and form a high-temperature sheet material; and the forming machine can directly process the high-temperature sheet material into a formed product by using the forming mechanism, and the forming mechanism can move synchronously with the high-temperature sheet material along the production line during processing.

The cooler is a rolling mechanism, the rolling mechanism includes two roller shafts disposed vertically in parallel, and heat conduction oil or deionized water is provided in the rolling mechanism.

During actual application, an air-cushion lifting mechanism is disposed between the cooler and the forming machine, and the air-cushion lifting mechanism is used to lift and convey the high-temperature sheet material through air flow.

The air-cushion lifting mechanism includes an air-flow generator and an air-guide plate disposed on an air outlet side of the air-flow generator.

Specifically, the air-flow generator includes an air blower or an air compressor.

The forming mechanism uses a blow molding process and a vacuum molding process.

During actual application, the main machine further includes: a filter, where the filter is disposed on a side, connected to the rolling mechanism, of the main machine; a die head, where the die head is disposed on a side, connected to the cooler, of the filter; and a melt pump, where the melt pump is disposed between the filter and the die head.

The forming machine further includes: a cutting mechanism, where the cutting mechanism and the forming mechanism are at a same working position, wherein the cutting mechanism is a laser cutting mechanism rather than a mechanical cutting mechanism, and a picking mechanism, where the picking mechanism is connected to the cutting mechanism, and the picking mechanism is disposed downstream of the cutting mechanism. It is noted that, in a cup forming system in prior art, it may be seen that a cutting mechanism and a forming mechanism are at a same working position, but it is totally different from that in the present application. In a cup forming system in prior art, while the cutting mechanism and the forming mechanism are at a same working position, but the raw material must be solid plastic sheet materials, but in the present application, the raw material can be viscous materials. At the same time, in a cup forming system in prior art, the cutting mechanism must be a mechanical cutting mechanism, but in the present application, a laser cutting mechanism in the form of a sheet, which is cheaper, and can cut a larger product than a cup forming system in prior art.

Specifically, the forming system further includes a scrap processing mechanism, where the scrap processing mechanism is connected to the picking mechanism, and the scrap processing mechanism is disposed downstream of the picking mechanism.

Compared with the prior art, the forming system of the present invention has the following advantages:

The forming system provided in the present invention includes: a main machine and a forming machine that are located at a same production line and are sequentially connected, wherein the main machine may include an extrusion mechanism, and the forming machine may include a forming mechanism. Specifically, the main machine can heat and stir a solid raw material into a viscous material by using the extrusion mechanism, and the forming machine can directly process the viscous material into a formed product by using the forming mechanism. As can be learned from the analysis, in the forming system provided in the present invention, the main machine can heat and stir a solid raw material into a viscous material by using the extrusion mechanism, and the forming machine can directly process the viscous material into a formed product by using the forming mechanism, i.e. the forming system provided in the present invention can process chemical raw materials to directly obtain a formed product. Compared with the forming process in the prior art, an intermediate process of forming a coiled sheet at room temperature is omitted, i.e. a coiled sheet at room temperature does not need to be made. Therefore, it is no longer necessary to wait a time required to heat the coiled sheet at room temperature into a molten state again. Therefore, the forming system provided in the present invention can ensure the continuity of a production line, so that the forming system provided in the present invention can effectively improve production efficiency. In addition, in the forming system provided in the present invention, only one time of heating is required in the main machine, so that two times of heating in the prior art (heating is separately required for a sheet processing process and a product forming process) are avoided. Therefore, energy consumption can be further effectively reduced.

The present invention further provides a forming method, including: Step S1, heating and stirring a solid raw material and extruding the solid raw material into a viscous material by using a screw rod; and Step S2, directly processing the viscous material into a formed product. And various plastic products having different areas or sizes can be produced at relatively low energy consumption and costs.

The advantages of the forming method compared with the prior art are the same as those of the foregoing forming system, which are no longer elaborated herein.

### BRIEF DESCRIPTION OF THE DRAWINGS

To describe the technical solutions in the specific implementations of the present invention or in the prior art more clearly, the following briefly introduces the accompanying drawings required for describing the specific implementations or the prior art. Apparently, the accompanying drawings in the following description show some implementations of the present invention, and persons skilled in the art may still derive other drawings from these accompanying drawings without creative efforts.

FIG. 1 is a schematic structural diagram of a forming system provided in an embodiment of the present invention;

FIG. 2 is a schematic structural diagram of a cooler in a forming system provided in an embodiment of the present invention;

FIG. 3 is a schematic flowchart of a forming method provided in an embodiment of the present invention;

FIG. 4 is a schematic flowchart of another forming method provided in an embodiment of the present invention;

FIG. 5 is a specific schematic structural diagram of a forming mechanism and a cutting mechanism provided in an embodiment of the present invention; and

FIG. 6 is a schematic diagram of a specific structure of a chain transmission mechanism and a specific connection relationship between the chain transmission mechanism and a sheet provided in an embodiment of the present invention.

### REFERENCE NUMERALS

1-main machine; 2-cooler;

3-forming machine; 11-extrusion mechanism;

31-forming mechanism; 21-rolling mechanism;

211-roller shaft; 12-filter;

13-die head; 14-melt pump;

32-cutting mechanism; 33-picking mechanism;

4-scrap processing mechanism;

17-blowing plate; 311-first servomotor;

313-first connecting rod; 314-second connecting rod;

131-mold;

312-second servomotor; 315-cam.

### DETAILED DESCRIPTION OF THE EMBODIMENTS

The technical solutions of the present invention will be clearly and thoroughly described below with reference to the accompanying drawings. Apparently, the described embodiments are some embodiments but are not all the embodiments of the present invention. Based on the embodiments of the present invention, all other embodiments derived by persons skilled in the art without any creative efforts shall fall within the protection scope of the present invention.

In the description of the present invention, it needs to be understood that orientation or location relationships indicated by terms “center”, “up”, “down”, “left”, “right”, “vertical”, “horizontal”, “inside”, and “outside” are based on orientation or location relationships shown in the accompanying drawings, and are only used to facilitate description of the present invention and simplify description, but are not used to indicate or imply that the apparatuses or elements must have specific orientations or are constructed and operated by using specific orientations, and therefore, cannot be understood as a limitation to the present invention. In addition, terms such as “first”, “second”, and “third” are only used for description, but cannot be used to indicate or imply relative importance.

In the present invention, it should be noted that unless otherwise expressly specified and defined, terms such as “mounted”, “connected”, and “connection” should be understood in a broad sense, for example, fixedly connected, detachably connected or integrally connected; or mechanically connected or electrically connected; or connected directly or through an intermediate, or two elements communicated internally. For persons skilled in the art, specific meanings of the terms in the present invention should be understood according to specific conditions.

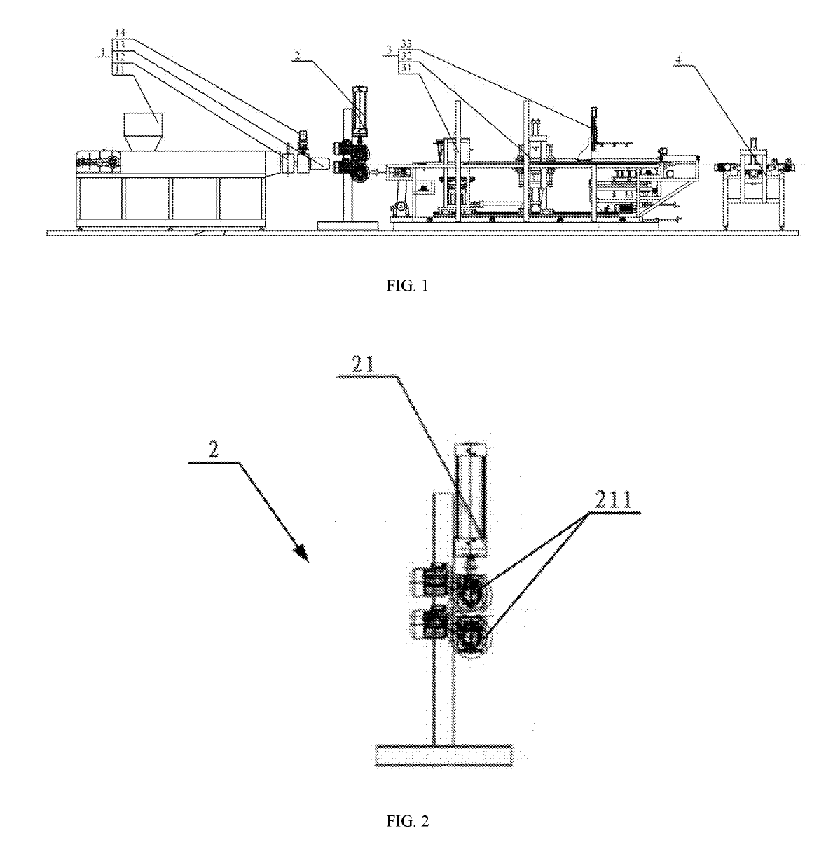

FIG. 1 is a schematic structural diagram of a forming system provided in an embodiment of the present invention.

As shown in FIG. 1, this embodiment of the present invention provides a forming system, including: a main machine 1 and a forming machine 3 that are located at a same production line and are sequentially connected. The main machine 1 includes an extrusion mechanism 11, and the forming machine 3 includes a forming mechanism 31. The main machine 1 can heat and stir a solid raw material into a viscous material by using the extrusion mechanism 11. The forming machine 3 can directly process the viscous material into a formed product by using the forming mechanism 31.

Compared with the prior art, the forming system in this embodiment of the present invention has the following advantages:

As shown in FIG. 1, the forming system provided in this embodiment of the present invention includes: a main machine 1 and a forming machine 3 that are located at a same production line and are sequentially connected. The main machine 1 may include an extrusion mechanism 11, and the forming machine 3 may include a forming mechanism 31. Specifically, the main machine 1 can heat and stir a solid raw material into a viscous material by using the extrusion mechanism 11. The forming machine 3 can directly process the viscous material into a formed product by using the forming mechanism 31. As can be learned from analysis, in the forming system provided in this embodiment of the present invention, the main machine 1 can heat and stir a solid raw material into a viscous material by using the extrusion mechanism 11, and the forming machine 3 can directly process the viscous material into a formed product by using the forming mechanism 31, i.e. the forming system provided in this embodiment of the present invention can process chemical raw materials to directly obtain a formed product. Compared with the forming process in the prior art, an intermediate process of forming a coiled sheet at room temperature is omitted, i.e. a coiled sheet at room temperature does not need to be made. Therefore, it is no longer necessary to wait a time required to heat the coiled sheet at room temperature into a molten state again. Therefore, the forming system provided in this embodiment of the present invention can ensure the continuity of a production line, so that the forming system provided in this embodiment of the present invention can effectively improve production efficiency. In addition, in the forming system provided in this embodiment of the present invention, only one time of heating is required in the main machine 1, so that two times of heating in the prior art (heating is separately required for a sheet processing process and a product forming process) are avoided. Therefore, energy consumption can be further effectively reduced.

It should be additionally described herein that in the forming system provided in this embodiment of the present invention, an intermediate process of forming a coiled sheet at room temperature can be omitted. Therefore, various problems in the process of forming the coiled sheet can be correspondingly avoided. The problems include, for example, equipment purchasing, personnel and quality control, and warehousing and transportation. In addition, problems such as sheet overstocking and fund occupation can be further solved.

During actual application, corresponding to a polypropylene (PP) material or a polystyrene (PS) material, as shown in FIG. 1, a cooler 2 may be connected between the main machine 1 and the forming machine 3. The cooler 2 can be used to reduce the temperature of the high-temperature viscous material (for example, a PP material at 170° C.) and form a high-temperature (120° C. to 130° C.) sheet material, so as to subsequently directly process the high-temperature sheet material into a formed product by using the forming mechanism 31 of the forming machine 3. In addition, the forming mechanism 31 can move synchronously with the high-temperature sheet material along the production line during processing, i.e. the forming mechanism 31 can synchronously and rapidly implement processing and forming while ensuring that the production line works continuously.

FIG. 2 is a schematic structural diagram of a cooler in a forming system provided in an embodiment of the present invention.

During actual application, as shown in FIG. 2, the cooler 2 may be a rolling mechanism 21. Specifically, the rolling mechanism 21 may include two roller shafts 211 disposed vertically in parallel, and heat conduction oil or deionized water may be provided in the rolling mechanism 21. The roller shafts 211 are disposed in the rolling mechanism 21, so that the quality of the high-temperature sheet material can be effectively improved and the high-temperature sheet material has relatively desirable fineness and smoothness. The heat conduction oil or deionized water can effectively reduce the temperature of the high-temperature liquid material, to enable the high-temperature liquid material to form the high-temperature sheet material and at the same time keep the temperature of the high-temperature sheet material.

Correspondingly, when the temperature of the PP or PS material is reduced by using the cooler 2 of the rolling mechanism 21 and the PP or PS material enters the forming mechanism 31, the forming mechanism 31 may directly process the high-temperature sheet material into a formed product by a blow molding process or a vacuum molding process.

During actual application, for a polyethylene terephthalate (PET) material, an air-cushion lifting mechanism may be disposed between the cooler 2 and the forming machine 3. The air-cushion lifting mechanism can be used to lift and convey the high-temperature sheet material through an air flow. Specifically, the air-cushion lifting mechanism may include an air-flow generator and an air-guide plate disposed on an air outlet side of the air-flow generator. Further, the air-flow generator may be an apparatus such as an air blower or an air compressor that can generate an air flow. The air blower or air compressor in the air-cushion lifting mechanism can provide cooled air, so that a high-temperature viscous material can form the high-temperature sheet material, and at the same time produce an effect of preventing melting and drooping. The air-guide plate can ensure the uniformity of the cooled air, so that the high-temperature sheet material has relatively desirable fineness and smoothness.

It should be additionally described herein that the forming mechanism 31 uses a blow molding process, through 4 to 6 atmospheres, which can be adjusted according to different requirements, to form a formed product having relatively high quality. In addition, to prevent the occurrence of spontaneous combustion and drooping of the high-temperature sheet material, causing that the high-temperature sheet material cannot enter a mold for forming, in the forming mechanism 31 provided in this embodiment of the present invention, a photoelectric system is used to detect a drooping degree of the high-temperature sheet material, to show corresponding different signal currents (for example, when a drooping amount is small, a signal current is small, and when a drooping amount is large, a signal current is large), and a solenoid valve is adjusted to provide different cooling air volumes, so as to control a drooping degree of the high-temperature sheet material to facilitate normal forming. Certainly, the temperature of a material cake may be adjusted in another manner, so as to avoid the phenomenon that the material cake droops.

Correspondingly, when a PET material enters the forming mechanism 31 through a lifting mechanism, the forming mechanism 31 should directly process the high-temperature sheet material into a formed product by a blow molding process and/or a vacuum molding process.

It should be additionally described herein that as the lifting mechanism is used, the PET material may be fixed and moved by using chains on two sides of the PET material, so as to reduce the temperature of the PET material as the PET material moves.

During actual application, to block a material that does not conform to a viscosity standard, as shown in FIG. 1, the main machine 1 may further include a filter 12. The filter 12 may be disposed on a side, connected to the rolling mechanism 21, of the main machine 1, so that by the filter 12, raw material residues that have not been thoroughly stirred into a viscous material or a material that does not conform to the viscosity standard can be effectively isolated, thereby ensuring that the cooler 2 can smoothly reduce the temperature of the high-temperature viscous material and enable the high-temperature viscous material to form the high-temperature sheet material.

To ensure that the viscous material can uniformly enter the cooler 2 to form a high-temperature sheet material that has uniform density and temperature distribution, as shown in FIG. 1, the main machine 1 may further include a die head 13. The die head 13 may be disposed on a side, connected to the cooler 2, of the filter 12. Because the die head 13 can enable the viscous material to be desirably and uniformly distributed in the die head 13, it can be ensured that the viscous material enters the cooler 2 uniformly and forms the high-temperature sheet material having relatively high quality. The forming system provided in this embodiment of the present invention can ensure that the high-temperature sheet material has uniform density and temperature distribution and has a continuous production line. Therefore, various products that have relatively large (0.2 millimeters to 2 millimeters) thicknesses and different areas can be produced, so that the range of products that can be produced is effectively expanded.

It should be additionally described herein that, in a forming process in the prior art, a melt can no longer bear its own weight before being thoroughly heated during heating and melting, therefore, only a relatively light and thin (a thickness does not exceed 0.7 millimeters) sheet can be processed, and as a result, the range of producing a product is limited.

Specifically, to facilitate the conveyance of a high-temperature high-viscosity viscous material, as shown in FIG. 1, the main machine 1 may further include a melt pump 14. The melt pump 14 may be disposed between the filter 12 and the die head 13. As the melt pump 14 is disposed, the conveyance of a high-temperature high-viscosity liquid material can be facilitated, and operations such as pressurization and measurement can be further facilitated.

During actual application, to make it convenient to cut an entire formed product and cut edges and corners to acquire independent products for sale, as shown in FIG. 1, the forming machine 3 may further include a cutting mechanism 32. The cutting mechanism 32 and the forming mechanism 31 are at a same working position, referring to FIG. 5. Cutting takes place immediately after forming, so that a forming and cutting system provided in this embodiment of the present invention can effectively improve production efficiency.

As shown in FIG. 1, the forming machine 3 may further include a picking mechanism 33. The picking mechanism 33 may be connected to the cutting mechanism 32, and the picking mechanism 33 may be disposed downstream of the cutting mechanism 32. In addition, the picking mechanism 33 can intermittently convey a formed product (an independent product for sale), to make it convenient to directly and rapidly place the formed product on a conveyor belt or at another corresponding mechanism.

It should be additionally described herein that, in the forming system provided in this embodiment of the present invention, the cutting mechanism 32, the picking mechanism 33, and the forming mechanism 31 can move synchronously with the formed product along the production line during processing. That is, the high-temperature sheet material and the formed product move uniformly together by using a conveyor system and the forming system. The forward and backward movement control of the forming mechanism 31, the cutting mechanism 32, and the picking mechanism 33 is: stillness, acceleration, uniform motion, deceleration, stillness.

Further, to improve the utilization of raw materials and avoid a waste of raw materials, as shown in FIG. 1, the foregoing forming system may further include a scrap processing mechanism 4. The scrap processing mechanism 4 may be connected to the picking mechanism 33, and the scrap processing mechanism 4 may be disposed downstream of the picking mechanism 33, so that as the scrap processing mechanism 4 is disposed, cut edges can be processed and conveyed to the main machine 1 again to implement scrap reuse, thereby improving the utilization of raw materials and avoiding a waste of raw materials.

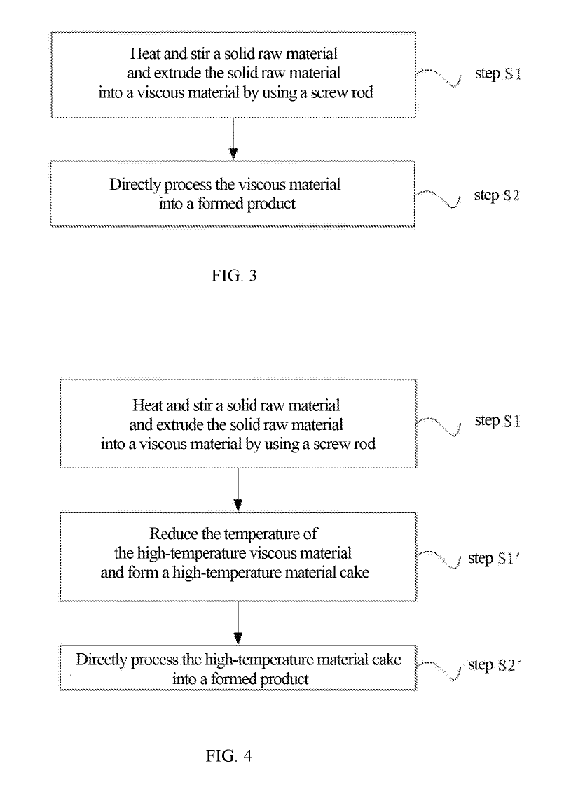

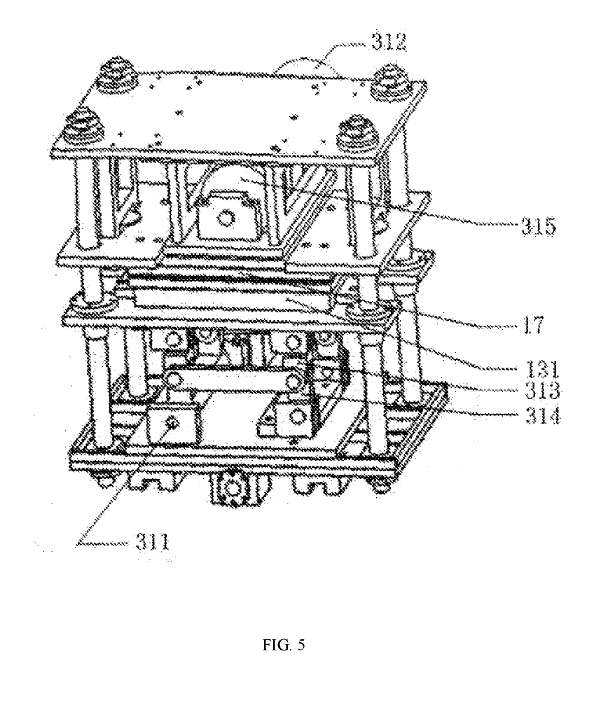

FIG. 3 is a schematic flowchart of a forming method provided in an embodiment of the present invention. FIG. 4 is a schematic flowchart of another forming method provided in an embodiment of the present invention.

This embodiment of the present invention further provides a forming method. As shown in FIG. 3, the forming method includes: Step S1, heating and stirring a solid raw material and extruding the solid raw material into a viscous material by using a screw rod; and Step S2, directly processing the viscous material into a formed product, alternatively, as shown in FIG. 4, the forming method includes: Step S1, heating and stirring a solid raw material and extruding the solid raw material into a viscous material by using a screw rod; Step S1′, reducing the temperature of the high-temperature viscous material and forming a high-temperature sheet material; and Step S2′, directly processing the high-temperature sheet material into the formed product. Specifically, with reference to FIG. 1, the extrusion mechanism 11 in the main machine 1 may be used to heat and stir a solid raw material into a viscous material, the cooler 2 of the rolling mechanism 21 or the lifting mechanism may be used to reduce the temperature of the high-temperature viscous material and form a high-temperature sheet material, and the forming mechanism 31 in the forming machine 3 then directly processes the high-temperature sheet material into a formed product.

FIG. 5 is a schematic structural diagram of a forming mechanism provided in an embodiment of the present invention.

As shown in FIG. 5, a shaft is driven by a first servomotor 311, and a first connecting rod 313 and a second connecting rod 314 are then driven, so that a mold 131 moves up and down. In addition, a second servomotor 312 drives a cam 315 to rotate. The cam 315 drives a blowing plate 17 to move up and down. A cutter is disposed at the bottom of the blowing plate 17. The cutter also moves up and down to cut off a product of blow molding.

A sheet is processed by the main machine to enter a viscous state and fed into a forming and cutting system. The blowing plate 17 moves downward to perform blow molding. The blowing plate 17 is then driven by the cam 315 to drive the cutter to move downward, so that a product is cut off. The connecting rods move to a picking mechanism and convey the product to a conveyor belt by using a lower ejector rod. The connecting rods then move downward with the mold, and the forming and cutting system returns to a starting point. A sheet plate and a product move on with a chain.

In the present invention, such a forming mechanism is used to cleverly combine two procedures in the prior art, so that the procedure becomes simple and a procedure process is shortened. In addition, because position is not changed after forming, cutting is highly accurate, and accordingly the problems in the prior art that two working positions are required and it is difficult to implement alignment for cutting are solved.

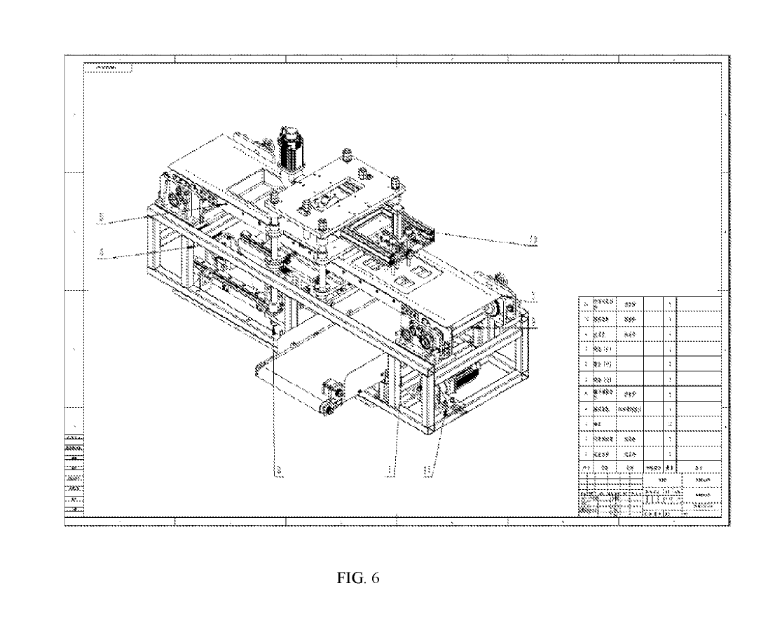

FIG. 6 is a schematic diagram of connection relationship of a chain transmission mechanism provided in an embodiment of the present invention.

As shown in FIG. 6, a sheet is hung on a chain, and during forming, the chain and a forming and cutting system move synchronously. After forming and cutting are completed, the forming and cutting system returns to a starting point.

In the forming method provided in this embodiment of the present invention, chemical raw materials are processed to directly obtain a formed product. Compared with a forming process in the prior art, an intermediate process of forming a coiled sheet at room temperature is omitted, i.e. a coiled sheet at room temperature does not need to be made. Therefore, it is no longer necessary to wait a time required to heat the coiled sheet at room temperature into a molten state again. Therefore, the forming method provided in this embodiment of the present invention can ensure the continuity of a production line, so that the forming method provided in this embodiment of the present invention can effectively improve production efficiency. In addition, in the forming method provided in this embodiment of the present invention, only one time of heating is required, so that two times of heating in the prior art (heating is separately required for a sheet processing process and a product forming process) are avoided. Therefore, energy consumption can be further effectively reduced.

Finally, it should be noted that the foregoing embodiments are merely intended for describing the technical solutions of the present invention rather than limiting the present invention. Although the present invention is described in detail with reference to the foregoing embodiments, persons skilled in the art should understand that they may still make modifications to the technical solutions described in the foregoing embodiments or make equivalent replacements to some or all technical features thereof, without departing from the scope of the technical solutions of the embodiments of the present invention.

### INDUSTRIAL APPLICABILITY

The present invention can ensure the continuity of a production line, so that the forming method provided in this embodiment of the present invention can effectively improve production efficiency. In addition, energy consumption can be further effectively reduced.

1. A forming system, comprising: a main machine and a forming machine that are located at a same production line and are sequentially connected, wherein the main machine comprises an extrusion mechanism, and the forming machine comprises a forming mechanism,
the main machine is capable of heating and stirring a solid raw material into a viscous material by using the extrusion mechanism, and the forming machine is capable of directly processing the viscous material into a formed product by using the forming mechanism.

2. The forming system according to claim 1, wherein a cooler is connected between the main machine and the forming machine, and the cooler is capable of being used to reduce the temperature of the high-temperature viscous material and form a high-temperature sheet material; and
the forming machine is capable of directly processing the high-temperature sheet material into the formed product by using the forming mechanism, and the forming mechanism is capable of moving synchronously with the high-temperature sheet material along the production line during processing.

3. The forming system according to claim 2, wherein the cooler is a rolling mechanism, the rolling mechanism comprises two roller shafts disposed vertically in parallel, and heat conduction oil or deionized water is provided in the rolling mechanism.

4. The forming system according to claim 2, wherein an air-cushion lifting mechanism is disposed between the cooler and the forming machine, and the air-cushion lifting mechanism is used to lift and convey the high-temperature sheet material by an air flow.

5. The forming system according to claim 4, wherein the air-cushion lifting mechanism comprises an air-flow generator and an air-guide plate disposed on an air outlet side of the air-flow generator.

6. The forming system according to claim 2, wherein the forming mechanism uses a blow molding process or a vacuum molding process.

7. The forming system according to claim 3, wherein the main machine further comprises:
a filter, wherein the filter is disposed on a side, connected to the rolling mechanism, of the main machine;
a die head, wherein the die head is disposed on a side, connected to the cooler, of the filter; and
a melt pump, wherein the melt pump is disposed between the filter and the die head.

8. The forming system according to claim 1, wherein the forming machine further comprises:
a cutting mechanism, wherein the cutting mechanism and the forming mechanism are at a same working position; and
a picking mechanism, wherein the picking mechanism is connected to the cutting mechanism, and the picking mechanism is disposed downstream of the cutting mechanism.

9. The forming system according to claim 8, wherein the forming system further comprises a scrap processing mechanism, wherein the scrap processing mechanism is connected to the picking mechanism, and the scrap processing mechanism is disposed downstream of the picking mechanism.

10. A forming method, comprising:
Step S1, heating and stirring a solid raw material and extruding the solid raw material into a viscous material by using a screw rod; and
Step S2, directly processing the viscous material into a formed product, and producing various plastic products having different areas or sizes at relatively low energy consumption and costs.
